(19) United States
(12) Patent Application Publication
(10) Pub. No.: US 2016/0333592 A1
(43) Pub. Date: Nov. 17, 2016

(54) CEILING LADDER

(71) Applicant: Theodore Alexander, The Villages, FL (US)

(72) Inventor: Theodore Alexander, The Villages, FL (US)

(21) Appl. No.: 15/009,769

(22) Filed: Jan. 28, 2016

Related U.S. Application Data
(60) Provisional application No. 62/162,221, filed on May 15, 2015.

(51) Int. Cl. E04F 11/06; E06C 1/34

(52) U.S. Cl. CPC E04F 11/064; E06C 1/34

(57) ABSTRACT

A foldable ceiling ladder assembly for installation within a ceiling opening includes a concealment panel sized and shaped to substantially cover the ceiling opening when the ladder is in a stowed configuration; the concealment panel including a swingout door portion capable of pivotal rotation away from the ladder when in a deployed configuration to permit uninhibited foot access on the ladder rungs by the user for improved safety and for facilitating ease of ascending and descending the ladder.

### RELATED APPLICATION

This application claims the benefit of U.S. Provisional Application No. 62/162,221 filed May 15, 2015 and entitled, Ceiling Ladder.

### FIELD OF THE INVENTION

The present invention pertains generally to ladders, and more particularly to those adapted for mounting in a ceiling opening for the purpose of providing access to the area there above.

### BACKGROUND OF THE INVENTION

A ceiling ladder, also known as an “attic ladder” or “loft ladder” is a retractable ladder that is installed into an opening in the floor of an attic and ceiling of the floor below the attic to facilitate passage from one floor to the other. They are used as an inexpensive and compact alternative to having a permanent staircase that ascends to the attic of the home or building in which they are installed.

Ceiling ladders of the prior art are typically of two general types, namely the folding type and telescopic type. Folding ceiling ladders include a ladder component which is normally in a contracted stowed configuration and may be extended in length to a deployed configuration by unfolding of two or more ladder sections which are hingedly attached to one another. As may be readily appreciated, ceiling ladders of the telescopic variety also include a ladder component normally in a contracted stowed configuration and extendable in length to a deployed configuration through telescopic extension of its subparts. In both varieties, extension and contraction of the ladder component may be carried out automatically or manually. In both varieties, the ladder component, when in its contracted stowed configuration, is typically stowed horizontally above the floor opening and concealed from view by a pivotable door or concealment panel component to which a portion of the ladder is fixedly attached. In common embodiments, the door is hinged to a side of the framing defining the opening and the door is attached directly to a portion of the ladder rails or indirectly but still in close proximity thereto. The door is sized and shaped to fill the opening and to lay flush with the surrounding ceiling when closed, and is typically opened by pulling on a depending drawstring Pulling on the drawstring to open the door automatically causes pivoting of the ladder to initiate its deployment, and pivoting of the ladder to its stowed configuration automatically initiates closing of the door.

For ceiling ladders of the folding type, because the door is fixedly attached either directly or in close proximity to the back of at least the upper portion of the ladder, the door interferes with proper foot placement on the adjacent ladder rungs creating a significant safety issue. More specifically, the door limits the depth of foot penetration across these rungs permitting only the toes of the foot to contact the rungs rather than a deeper penetration that would include the ball and arch of the foot which affords more stable foot placement. Although it is typically recommended that users always face the ladder while ascending and descending the ladder, it is common practice to descend ceiling ladders facing away from the ladder such as to permit carrying of items stored in the attic or other space being accessed. In such cases, only the heel portion of the user's feet can make contact with the rungs further adding to the risk of a fall.

It would, therefore, be ideal to have known in the art ceding ladder assembly that affords safer foot placement on the ladder rungs.

### SUMMARY OF THE INVENTION

According to one aspect of the present invention, there is provided A foldable ceiling ladder for installation within a ceiling opening defined by framing members, the ceiling ladder comprising a ladder comprising a first ladder section hingedly attached to a second ladder section; each said first ladder section and said second ladder section comprising a pair of parallel rails connected to one another by a plurality of incrementally spaced rungs; said ladder having a deployed configuration wherein said first and ladder section and said second ladder section are aligned to form a continuous ladder, and a stowed configuration wherein said first ladder section and said second ladder section are foldable upon themselves above the ceiling opening when said ceiling ladder is not in use; mounting means for pivotally mounting said first ladder section to a framing member along a first axis of rotation; and a concealment panel sized and shaped to substantially cover the ceiling opening, said concealment panel having a first portion fixedly attached to said first ladder section in co-planar fashion, and a second portion in coplanar alignment with said first portion and parallel to said rails of said first ladder section when said ladder is in said stowed configuration, and out-of-plane with said fixed portion and non-parallel to said rails of said first ladder section when said ladder is in said deployed configuration, whereby pivoting of the second portion of said concealment panel away from said ladder permits uninhibited foot access to said ladder rungs by a user.

In certain embodiments, the fixed portion and door portion of the concealment panel share the same axis of rotation. In certain embodiments, the fixed portion and door portion of the concealment panel have a different but parallel axis of rotation. In certain embodiments of the invention, the concealment panel is not divided into a fixed portion and a door portion; the entire concealment panel is hinged to the framing of the ceiling opening, is removably attached to the first ladder section for concealing the ceiling opening when the ladder is in its stowed configuration, and is capable of pivoting away from the ladder rungs when the ladder is in its deployed configuration to permit the desired increased foot access to the ladder rungs.

Certain embodiments further include at least one stowage latch configured to retain the door portion in its closed position (i.e., in coplanar alignment with the fixed portion of the concealment panel) until the stowage latch is released. In those embodiments where the entire concealment panel is adapted for pivotal rotation (i.e., where there is no door portion) one or more stowage latches are included to retain the concealment panel in proximity to the ladder for the purpose of ladder stowage and opening concealment.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the included abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore a primary object of the subject invention to provide a ceiling ladder that not only provides concealment of the ladder and ceiling opening when the ladder is in its stowed configuration, but also permits uninhibited foot access on all ladder rungs by the user thereby enhancing safety when ascending and descending the ladder.

It is also a primary object of the subject invention to provide a ceiling ladder designed for rapid installation within a framed ceiling opening.

It is also an object of the subject invention to provide a ceiling ladder that is simple in design and therefore capable of rapid construction and assembly at a relatively low cost. These together with other objects of the invention along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings herein:

FIG. 1 is a perspective view of foldable ceiling ladder of the prior art, shown in its deployed configuration;

FIG. 2 is a left side elevation view of the foldable ceiling ladder of FIG. 1 shown in its stowed configuration;

FIG. 3 is a left side elevation view of the ceiling ladder of FIG. 1 illustrating how the concealment panel impedes proper foot placement on the ladder rungs;

FIG. 4 is a perspective view of a foldable ceiling ladder of the subject invention, shown in its deployed configuration;

FIG. 5 is a left side elevation view of the foldable ceiling ladder of FIG. 4 shown in its stowed configuration;

FIG. 6 is a left side elevation view the ceiling ladder of FIG. 4 illustrating the door portion of the concealment panel;

FIG. 7 is a bottom view of the ceiling ladder of FIG. 4 illustrating how the concealment panel and door portion thereof share a common axis of rotation;

FIG. 8 is a perspective view of one embodiment of a shared hinge arrangement for the concealment panel and door portion thereof of a ceiling ladder of the subject invention;

FIG. 9 is a bottom view of a ceiling ladder of the subject invention illustrating how the concealment panel and door portion thereof share different but parallel axes of rotation; and

FIG. 10 is a perspective view of one embodiment of a parallel hinge arrangement for the concealment panel and door portion thereof of a ceiling ladder of the subject invention.

### DETAILED DESCRIPTION OF THE PREFERRED EMBODIMENT

It should be clearly understood at the outset like reference numerals are intended to identify the same structural elements, portions or surfaces consistently throughout the several drawings herein, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, any reference to the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. The terms “rung” or “rungs” of a ladder shall also include ladder “steps” or “treads” between ladder rails. Except where the context requires otherwise, the term “attic” as used herein means any space having a floor or surface with an opening through which a person can pass and an accessible lower level area or floor below the attic floor into which a ladder can be extended and from which a person can ascend the ladder through the opening. Similarly, the area below the attic is referred to generically herein as the “bottom floor”, and the floor of the attic is sometimes referred to as the “ceiling” of the bottom floor.

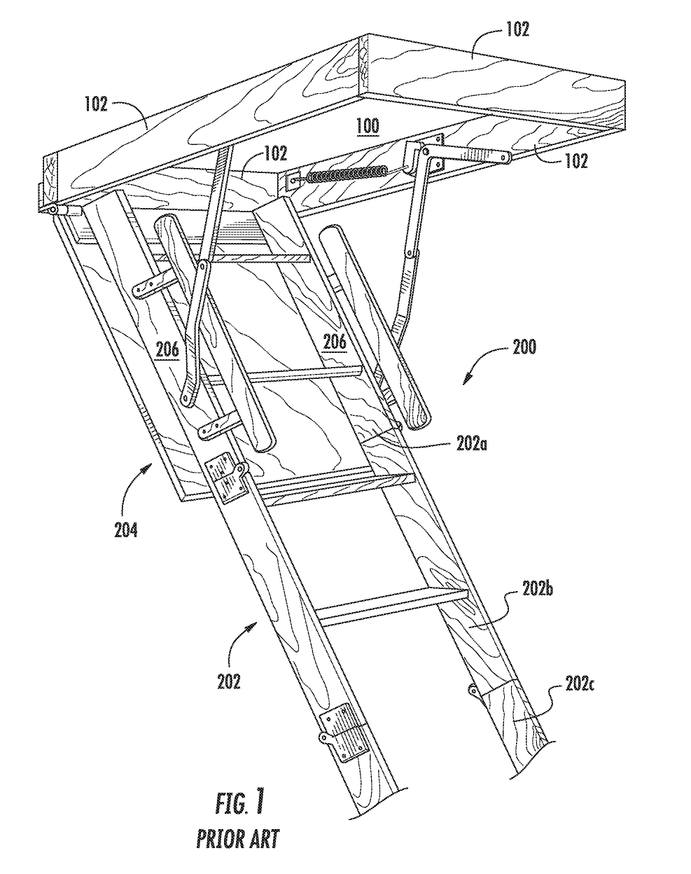

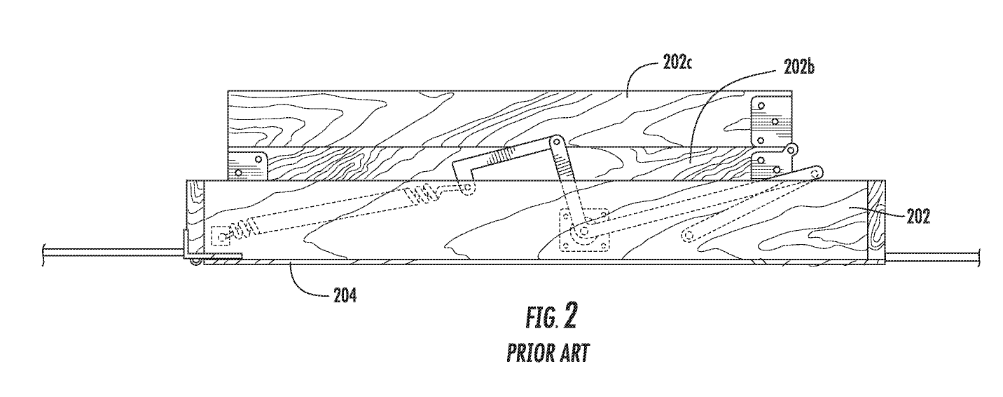

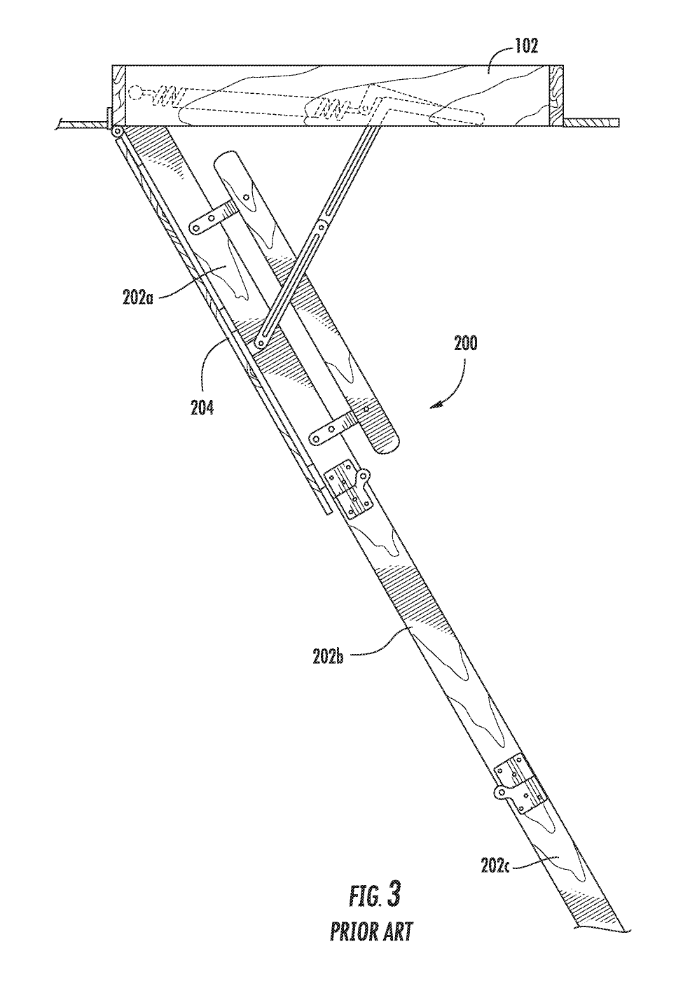

Before describing the construction and operation of the subject folding ceiling ladder, it is helpful to understand the construction of conventional ceiling ladders and their shortcomings. Accordingly, reference is first made to FIGS. 1-3 depicting a folding ceiling ladder 200 of the prior art. Folding ceiling ladder 200 includes a ladder component 202 which is normally in a contracted stowed configuration (FIG. 2) and which may be extended in length to a deployed configuration (FIGS. 1 and 3) by unfolding of two or more ladder sections 202a,b,c which are hingedly attached to one another. The ladder component, when in its contracted stowed configuration, is typically stowed horizontally above the floor opening and concealed from view by a pivotably mounted door 204 (also known as a “concealment panel”) to which ladder 200 is fixedly attached. In common embodiments, the door 204 is hinged to a side of the framing 102 defining an opening 100 in the ceiling. Door 204 is typically attached to the back of the ladder rails 206 in abutting coplanar relationship. The door is sized and shaped to fill the opening and to lay flush with the surrounding ceiling when closed, and is typically opened by pulling on a depending drawstring (not shown). Pulling on the drawstring to open the door automatically causes pivoting of the attached ladder to initiate its deployment, and pivoting of the ladder to its stowed configuration automatically initiates closing of the attached door. Because the door 204 is fixedly attached to the back of the ladder 200, spanning across its rails 206, it interferes with, proper foot placement on the adjacent ladder rungs creating a significant safety issue as described supra. The improved ceiling ladder of the subject invention obviates this problem by allowing a portion of the concealment panel, namely the portion between the ladder rails, to pivot away from the ladder to provide improved foot access to the ladder rungs.

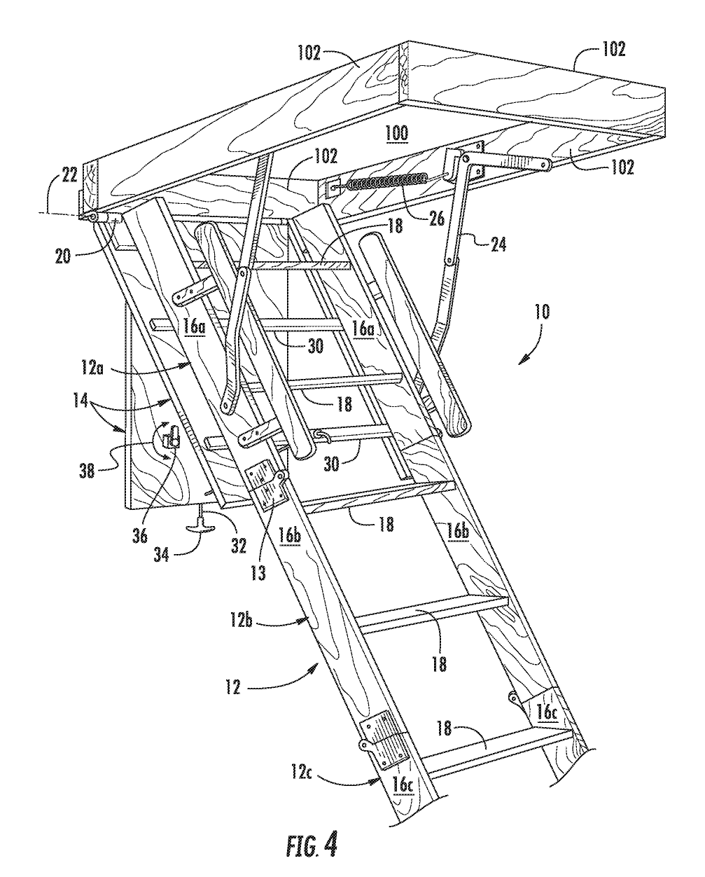

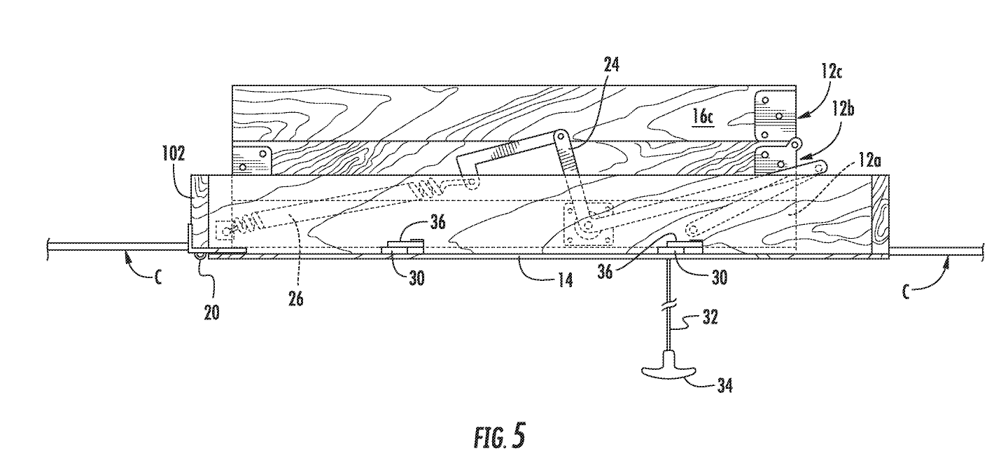

Accordingly, reference is now made to FIGS. 4-6 in which there is illustrated a preferred embodiment of a ceiling ladder of the subject invention designated generally by reference numeral 10 and of the folding ladder variety. Ceiling ladder 10 is designed for installation within a ceiling opening 100 defined by framing members 102 and is comprised of two primary components, namely a folding ladder assembly 12, and a concealment panel 14 sized and shaped to cover the ceiling opening 100. As is well known in the art, when ceiling ladder 10 is mounted within opening 100, the ladder assembly 12 is normally in a contracted stowed configuration (FIG. 2) and may be extended in length to a deployed configuration (FIGS. 1 and 3) by unfolding of its at least two ladder sections 12a,b,c which are hingedly attached to one another in series via hinges 13. Conversely, when ladder assembly 12 is in its contracted towed configuration with its ladder sections 12a,b,c folded one on top of the other, it is stowed horizontally above the floor opening 100 and concealed from view by concealment panel 14 to which ladder assembly 12 is fixedly attached.

In the embodiment illustrated, ladder assembly 12 is comprised of a first ladder section 12a hingedly attached via a hinge 13 to a second ladder section 12b which in turn is hingedly attached via another hinge 13 to a third ladder section 12c. In other embodiments a fewer or greater number of ladder sections may be employed. Ladder sections 12a,b,c comprise a pair of parallel rails 6a,b,c, respectively, each rail being connected to its neighboring rail by a plurality of incrementally spaced rungs 18. Mounting means are included for pivotally mounting the first ladder section 12a to a framing member 102. In a preferred embodiment, the mounting means comprises at least one hinge 20 pivotally connecting first ladder section 12 to framing member 102 along a first axis of rotation 22 such that ladder section 12a and the other ladder sections attached to it are capable of downward rotation from a horizontal stowed position to an angular deployed position. A pair of articulating mounting brackets 24 connect each side rail 16a of ladder section 12a to opposing framing members 102 in order to provide support and stability to ladder assembly 12. A pair of springs 26 operably connected between each mounting bracket 24 and the framing member 102 to which it is connected controls the rate of decent of the ladder assembly 12 and limits the amount of force required to return the ladder assembly 12 to its stowed position above the ceiling C in a manner well known in the art. As may be readily appreciated, different bracket and spring arrangements may be employed for these purposes, the example described above being only for illustrative purposes.

Concealment panel 14 includes a first portion 14a fixedly attached to the back of side rails 16a of first ladder section 12a in co-planar relationship. The attachment may be a direct attachment or, as illustrated in the instant embodiment, concealment panel 14 may be fixedly attached to one or more cross members 30 transversely mounted to the back of side rails 16a connecting one rail with the other. First portion 14a of concealment panel 14 is pivotally attached to a frame member 102 via panel hinge 20 having an axis of rotation 22 parallel to ladder rungs 18.

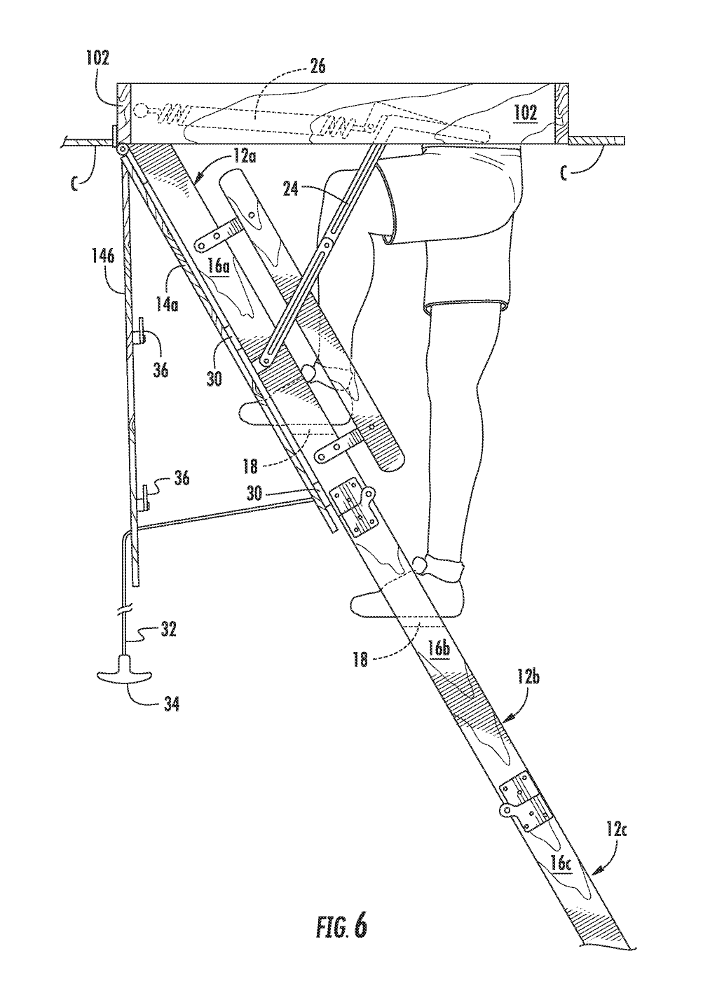

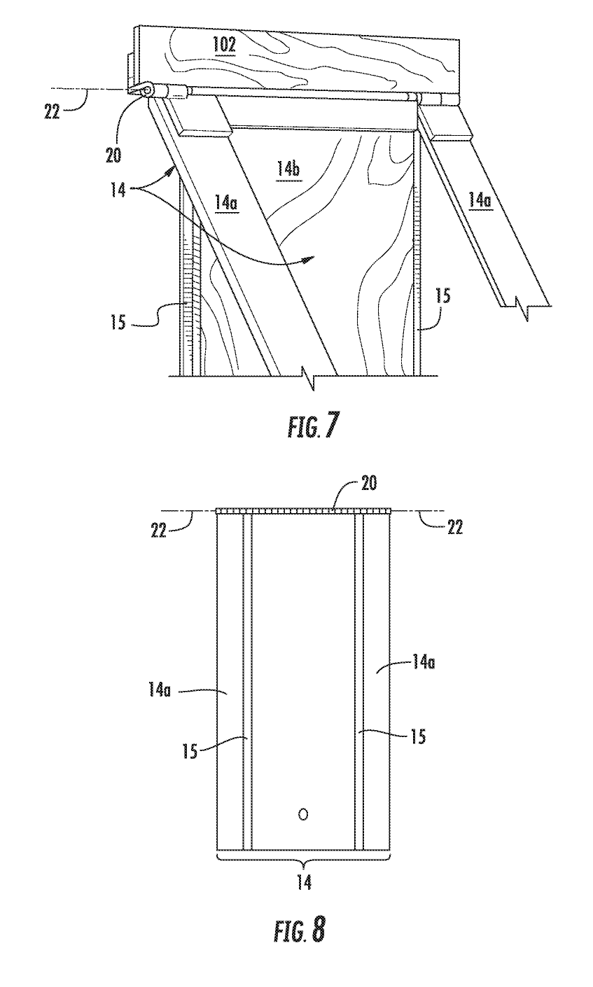

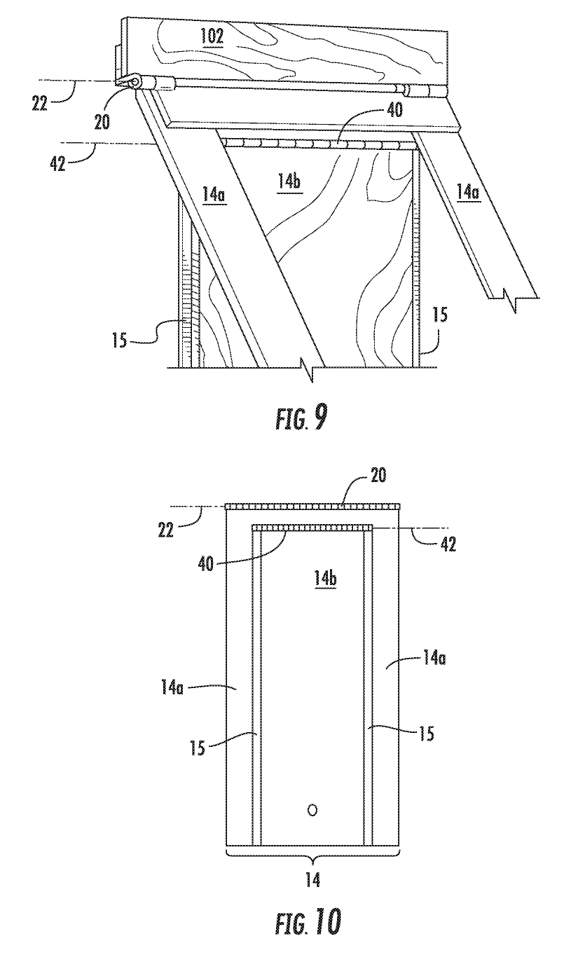

Concealment panel 14 further includes a second portion 14b (also referred to herein as “door portion 14b”) in the form of a pivotable door sized and shaped to substantially conform to the area between side rails 16a of first ladder section 12a. With additional reference now being made to FIGS. 7 and 8, in one embodiment door portion 14b is pivotably mounted to frame member 102 via panel hinge 20 thereby sharing a common axis of rotation 22 with first portion 14a. In this embodiment, first portion 14a is more accurately comprised of two parallel panel's separated by door portion 14b. With reference now being made to FIGS. 9 and 10, in another embodiment door portion 14b of concealment panel 14 is pivotably mounted to first portion 14 via door hinge 40 having second axis of rotation 42 which is parallel to axis of rotation 22 of hinge 20. In both of the above described embodiments, door portion 14b is in coplanar alignment with the first portion of concealment panel 14 and parallel to rails 16a of first ladder section 12a when the ladder assembly 12 is in its stowed configuration, and out of plane with the first portion of concealment panel 14 and non-parallel to rails 16a of the first ladder section 12a when the ladder assembly 12 is in its deployed configuration. Door portion 14b may further include longitudinal flanges 15 depending from its side edges. Flanges 15 overlap the side edges of first portion 14a of concealment panel 14 when door portion 14b is in its closed position, thus bridging the gaps between first portion 14a and door portion 14b for insulation and aesthetic purposes.

With specific reference to FIG. 6, as should be appreciated, when ladder assembly 12 is lowered from its horizontal stowed configuration to its deployed configuration by downward rotation of concealment panel 14 about its axis of rotation 22, door portion 14b may then be rotated downwardly about its axis of rotation 22 or 42 to swing away from the normally adjacent ladder rungs 18 thereby permitting deeper foot penetration across the rungs than would be possible if concealment panel 14 remained in abutting relationship with said rungs as is the case with ceiling ladders of the prior art.

Certain embodiments further include at least one stowage latch 36 configured to retain the door portion 14b in its closed position (i.e., in coplanar alignment with the first portion 14a of concealment panel 14) until the stowage latch is released allowing door portion 14b to rotate downwardly by virtue of gravity. In the embodiment illustrated, each latch 36 is rotated about its axis of rotation as illustrated by directional arrow 38 (FIG. 4) until it depends from an adjacent cross member 30. As will be readily appreciated by those skilled in the art, a myriad of other latching mechanisms may be employed to releasably retain door portion 14b in coplanar relationship with first portion 14a of concealment panel 14.

For those embodiments of the subject ceiling ladder 10 that require manual operation to raise and lower the apparatus from its stowed position above the ceiling to its operable or deployed position, a drawstring 32 is disposed through a cross member 30 of ladder assembly 12 and through concealment panel 14 and terminates in at least one end in handle 34. Pulling on the handle when door portion 14b is latched in coplanar alignment with first portion 14a of concealment panel 14 causes pivoting of the ladder assembly 12 to initiate its deployment. Pulling on the opposite end of the drawstring, which may also be adapted with a handle, causes pivoting of door portion 14b upwardly for latching to its counterpart first portion 14a. Pivoting of the concealment panel 14 upwardly initiates its closing and stowage of ladder assembly 12 above the ceiling.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A foldable ceiling ladder for installation within a ceiling opening defined by framing members, the ceiling ladder comprising:
a. a ladder comprising a first ladder section hingedly attached to a second ladder section; each said first ladder section and said second ladder section comprising a pair of parallel rails connected to one another by a plurality of incrementally spaced rungs; said ladder having a deployed configuration wherein said first and ladder section and said second ladder section are aligned to form a continuous ladder, and a stowed configuration wherein said first ladder section and said second ladder section are foldable upon themselves above the ceiling opening when said ceiling ladder is not in use;
b. mounting means for pivotally mounting said first ladder section to a framing member along a first axis of rotation; and
c. a concealment panel sized and shaped to substantially cover the ceiling opening, said concealment panel having a first portion fixedly attached to said first ladder section in co-planar fashion, and a second portion in coplanar alignment with said first portion and parallel to said rails of said first ladder section when said ladder is in said stowed configuration, and out-of-plane with said fixed portion and non-parallel to said rails of said first ladder section when said ladder is in said deployed configuration, whereby pivoting of the second portion of said concealment panel away from said ladder permits uninhibited foot access to said ladder rungs by a user.

2. The ceiling ladder of claim 1, wherein said second portion of said concealment panel is pivotably mounted about said first axis of rotation.

3. The ceiling ladder of claim 1, wherein said second portion of said concealment panel is pivotably mounted to said first portion of said concealment panel about a second axis of rotation; said first axis of rotation and said second axis of rotation being parallel.
